(19) United States
(12) Patent Application Publication
(10) Pub. No.: US 2014/0233885 A1
(43) Pub. Date: Aug. 21, 2014

(54) PHOTON-TO-PLASMON COUPLER

(71) Applicant: HUMBOLDT-UNIVERSITÄT BERLIN, Berlin (DE)

(72) Inventors: Andreas SCHELL, Berlin (DE); Rico Henze, Prenzlau (DE); Prof. Dr. Oliver Benson, Berlin (DE); Günter Kewes, Berlin (DE)

(73) Assignee: HUMBOLDT-UNIVERSITÄT BERLIN, Berlin (DE)

(21) Appl. No.: 13/770,157

(22) Filed: Feb. 19, 2013

(51) Int. Cl. G02B 6/26

(52) U.S. Cl. CPC G02B 6/26
USPC 385/27

(57) ABSTRACT

An embodiment of the present invention relates to a photon-to-plasmon coupler for converting photons to plasmons or vice versa, said photon-to-plasmon coupler comprising
a photonic waveguide for guiding photons,
a plasmonic waveguide for guiding plasmons, and
two plasmonic strip waveguides,
each of said two plasmonic strip waveguides being connected to said plasmonic waveguide and embracing an end section of the photonic waveguide such that each of said plasmonic strip waveguides is optically coupled to the end section of the photonic waveguide.

The present invention relates to photon-to-plasmon couplers for converting photons to plasmons or vice versa.

### BACKGROUND OF THE INVENTION

During the last decade the field of quantum plasmonics has developed into a fast growing research area [1]. For quantum optics experiments on a chip and for the miniaturization of optical applications, plasmons promise unique opportunities since they can beat the diffraction limit of light, reaching extremely high electromagnetic energy densities and low mode volumes [2]. Thus, plasmonic structures offer the tools necessary to achieve a higher level of control to light-matter interactions on a nanometer scale.

A key step in order to make use of these features is an efficient and controlled in- and out-coupling of plasmons to and from plasmonic structures [3]. For example, in proposed single-photon transistors [4] efficient photon-to-plasmon waveguide coupling is crucial. Furthermore, on-chip detection of plasmons is challenging [5] so that scattering of plasmons into photons and their subsequent detection with standard optical technology seems more feasible at present. Therefore, a number of photon-to-plasmon coupler schemes have been numerically investigated in two dimensions (2D) [6-8] and three dimensions (3D) [9-16] some of which have been fabricated in recent years [9-11].

Nevertheless, the above coupler schemes exhibit certain shortcomings in particular with respect to quantum plasmonics, so that novel designs are required. Specifically, these designs should allow for easy and reliable fabrication, e.g. via standard electron beam techniques.

### OBJECTIVE OF THE PRESENT INVENTION

An objective of the present invention is to present a photon-to-plasmon coupler that is easy to fabricate and provides a good coupling efficiency between photonic and plasmonic waveguides.

### BRIEF SUMMARY OF THE INVENTION

An embodiment of the invention is directed to a photon-to-plasmon coupler for converting photons to plasmons or vice versa, said photon-to-plasmon coupler comprising
a photonic waveguide for guiding photons,
a plasmonic waveguide for guiding plasmons, and
two plasmonic strip waveguides,
each of said two plasmonic strip waveguides being connected to said plasmonic waveguide and embracing an end section of the photonic waveguide such that each of said plasmonic strip waveguides is optically coupled to the end section of the photonic waveguide.

This embodiment of the present invention exhibits a very high coupling efficiency. The coupling results from an evanescent field between the plasmonic strip waveguides and the photonic waveguide. The coupling efficiency has been confirmed by 3D-simulation of the results which are described further below with reference to the figures.

Preferably, the two plasmonic strip waveguides form a Y-shaped plasmonic strip waveguide structure that converges towards the plasmonic waveguide and embraces the end section of the photonic waveguide.

Two stripe-like gaps may be formed between the Y-shaped plasmonic strip waveguide structure and the end section of the photonic waveguide. Via the width of the gap, the coupling behaviour may be optimized. The ratio between the width of the gap and the width of the plasmonic strip waveguides is preferably between 0.01 and 2.

The width of the gap between one of the plasmonic strip waveguides and the end section of the photonic waveguide preferably equals the width of the gap between the other one of the plasmonic strip waveguides and the end section of the photonic waveguide.

The width of the gap between the first section of each of the plasmonic strip waveguides and the end section of the photonic waveguide may be at least partially constant along the propagation direction of the photons and plasmons.

Preferably, the waveguide width of the plasmonic strip waveguides is at least partially or entirely constant along the propagation direction of the photons and plasmons. The plasmonic strip waveguides are preferably plasmonically decoupled from one another by the end section of the photonic waveguide.

Each of the plasmonic strip waveguides preferably comprises a first section being coupled to the photonic waveguide, and a second section that is less coupled to the photonic waveguide than the first section or entirely decoupled from the photonic waveguide.

The ratio between the length of the second section of each of the plasmonic strip waveguides and the width of the photonic waveguide is preferably between 1 and 4.

The photonic waveguide may comprise a middle section adjacent to the end section. The waveguide width of the middle section of the photonic waveguide may be larger than the width of each of the plasmonic strip waveguides. Alternatively, the waveguide width of the middle section of the photonic waveguide and the width of each plasmonic strip waveguide may be equal.

The end section of the photonic waveguide is preferably tapered, e.g. adiabatically tapered. The term “adiabatically tapered” refers to a taper that changes its waveguide width so smoothly that the additional losses caused by the taper are negligible.

The plasmonic waveguide may be a strip waveguide and may form a third plasmonic strip waveguide of the photon-to-plasmon coupler. Alternatively, the plasmonic waveguide may be a slot waveguide that is connected to each of the plasmonic strip waveguides.

The width of each of the plasmonic strip waveguides is preferably either smaller than the width of the plasmonic waveguide or as large as the width of the plasmonic waveguide.

A further embodiment of the present invention relates to a photon-to-plasmon coupler for converting photons to plasmons or vice versa, said photon-to-plasmon coupler comprising
a photonic waveguide for guiding photons,
a plasmonic waveguide for guiding plasmons, and
two plasmonic strip waveguides, that converge towards the plasmonic waveguide and form a Y-shaped plasmonic strip waveguide structure,
said Y-shaped plasmonic strip waveguide structure being optically coupled to an end section of the photonic waveguide.

As discussed above, a Y-shaped plasmonic strip waveguide structure supports an evanescent coupling between the two plasmonic strip waveguides and the photonic waveguide.

A further embodiment of the present invention relates to a photon-to-plasmon coupler for converting photons to plasmons or vice versa, said photon-to-plasmon coupler comprising
a photonic waveguide for guiding photons,
a plasmonic waveguide for guiding plasmons, and
two plasmonic strip waveguides,
each of said two plasmonic strip waveguides being coupled to an end section of the photonic waveguide but separated from the end section of the photonic waveguide by a gap.

As discussed above, the width of the gap provides a further parameter for optimizing the evanescent coupling between the two plasmonic strip waveguides and the photonic waveguide.

### BRIEF DESCRIPTION OF THE DRAWINGS

In order that the manner in which the above-recited and other advantages of the invention are obtained will be readily understood, a more particular description of the invention briefly described above will be rendered by reference to specific embodiments thereof which are illustrated in the appended figures. Understanding that these figures depict only typical embodiments of the invention and are therefore not to be considered to be limiting of its scope, the invention will be described and explained with additional specificity and detail by the use of the accompanying drawings:

FIG. 1 shows a first exemplary embodiment of a photon-to-plasmon coupler according to the present invention.

FIG. 2 shows the energy flux Φ along the surface plasmon waveguide after the coupling process of the coupler shown in FIG. 1. The flux is normalized to the incoming energy flux Φ0. The fast decay at the beginning corresponds to scattered light whereas the slow decay fits to the predicted waveguide damping and thus corresponds to the guided plasmon mode. The intensity value at a propagation length of zero gives the coupling efficiency η.

FIG. 3 shows—with respect to the coupler shown in FIG. 1—the field distribution (intensity) of the momentum-matched guided (a) dielectric and (b) plasmonic mode.

FIG. 4 shows—with respect to the coupler shown in FIG. 1—a top view on electrical field distribution (component parallel to SiO2 surface) at the interface between air and the SiO2-substrate with the mesh of the coupler geometry (only upper half).

FIG. 5 shows—with respect to the coupler shown in FIG. 1—the dependence of the coupling efficiency on the taper-length L1 starting from the optimized structure revealing an oscillatory behavior. The solid line is fit of the data with the analytic model A*exp(−Bx)*cos(Cx)+D.

FIG. 6 shows—with respect to the coupler shown in FIG. 1—the wavelength dependence of the coupling efficiency η of the optimized structure. The solid line is a guide for the eye.

FIGS. 7-15 show an exemplary embodiment of process steps for fabricating the photon-to-plasmon couplers of FIGS. 1 and 16.

FIG. 16 shows a second exemplary embodiment of a photon-to-plasmon coupler according to the present invention.

### DETAILED DESCRIPTION OF THE PREFERRED EMBODIMENTS

The preferred embodiments of the present invention will be best understood by reference to the drawings, wherein identical or comparable parts are designated by the same reference signs throughout.

It will be readily understood that the present invention, as generally described herein, could vary in a wide range. Thus, the following more detailed description of the exemplary embodiments of the present invention, is not intended to limit the scope of the invention, as claimed, but is merely representative of presently preferred embodiments of the invention.

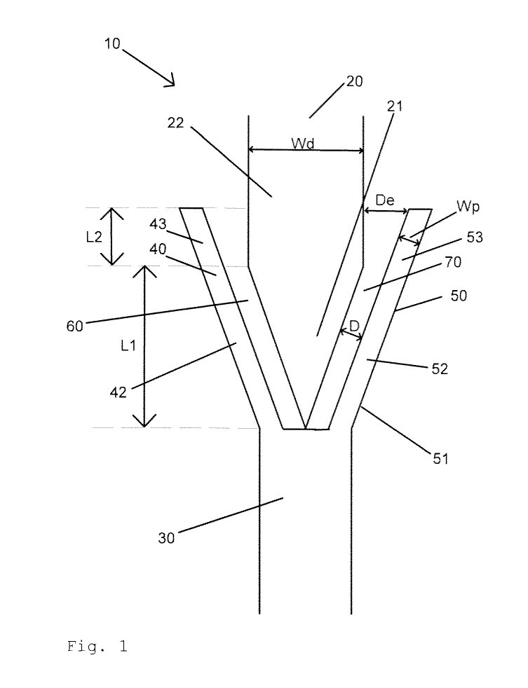

FIG. 1 shows a first exemplary embodiment of a photon-to-plasmon coupler 10 according to the present invention. The photon-to-plasmon coupler 10 comprises a photonic waveguide 20 for guiding photons. The photonic waveguide 20 is preferably a dielectric waveguide.

The photon-to-plasmon coupler 10 further comprises a plasmonic waveguide 30 for guiding plasmons and two plasmonic strip waveguides 40 and 50. The plasmonic waveguide 30 and the two plasmonic strip waveguides 40 and 50 are preferably made of metal.

The two plasmonic strip waveguides 40 and 50 are connected to the plasmonic waveguide 30 and embrace an end section 21 of the photonic waveguide 20 such that each of the plasmonic strip waveguides 40 and 50 is optically coupled to the end section 21 of the photonic waveguide 20.

FIG. 1 shows that the two plasmonic strip waveguides 40 and 50 form a Y-shaped plasmonic strip waveguide structure 51 that converges towards the plasmonic waveguide 30 and embraces the end section 21 of the photonic waveguide 20. The two plasmonic strip waveguides 40 and 50 are also referred to as V-shaped metal arms hereinafter.

Two stripe-like gaps 60 and 70 are formed between the Y-shaped plasmonic strip waveguide structure 51 and the end section 21 of the photonic waveguide 20. The width D of the gaps 60 and 70 strongly influences the coupling behaviour of the photon-to-plasmon coupler 10.

The ratio between the width D of the gaps 60 and 70 and the width Wp of the plasmonic strip waveguides 40 and 50 is preferably between 0.01 and 2. The width D of the gap 60 between the plasmonic strip waveguide 40 and the end section 21 of the photonic waveguide 20 preferably equals the width D of the gap 70 between the plasmonic strip waveguide 50 and the end section 21 of the photonic waveguide 20.

The plasmonic strip waveguides 40 and 50 preferably comprise a first section 42 and 52 that is coupled to the photonic waveguide 20, and a second section 43 and 53 that is less coupled to the photonic waveguide 20 than the first section 42 and 52 or entirely decoupled from the photonic waveguide 20.

The width D of the gaps 60 and 70 between the first section 42 and 52 of both plasmonic strip waveguides 40 and 50 and the end section 21 of the photonic waveguide 20 is preferably at least partially constant along the propagation direction of the photons and plasmons. In addition, the waveguide width Wp of the plasmonic strip waveguides 40 and 50 is at least partially or entirely constant along the propagation direction of the photons and plasmons.

The ratio between the length L2 of the second section 43 and 53 of the plasmonic strip waveguides 40 and 50 and the width Wd of the photonic waveguide 20 in a middle section 22 is preferably between 1 and 4.

The end section 21 of the photonic waveguide 20 is preferably adiabatically tapered.

In the embodiment shown in FIG. 1, the plasmonic waveguide 30 is a strip waveguide and forms a third plasmonic strip waveguide of the photon-to-plasmon coupler 10.

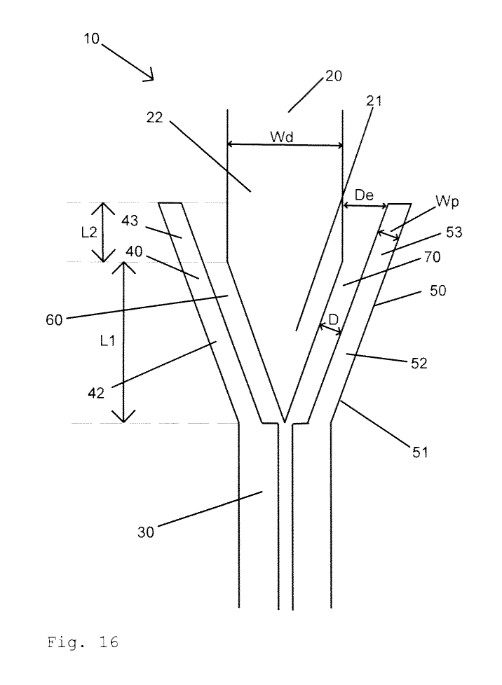

Alternatively, the plasmonic waveguide 30 may be a slot waveguide that is connected to each of the plasmonic strip waveguides. Such an embodiment is shown in FIG. 16.

Preferred materials for the plasmonic waveguide 30 and the two plasmonic strip waveguides 40 and 50 are silver, gold, copper, and aluminium. The photonic waveguide 20 is preferably a dielectric waveguide which may consist of or comprise silicon, silicon dioxide, silicon nitride, gallium phosphide, and/or acrylic glass.

Typical sizes of the photonic waveguide 20 are heights from 50 nm to 5 μm and widths of 100 nm to 10 μm. The typical sizes of the plasmonic waveguides 30, 40 and 50 are widths of 50 nm to 10 μm and heights of 10 nm to 300 nm.

The photon-to-plasmon coupler 10 may be optimized with simulation tools. The explanations hereinafter and the results discussed with regard to specific dimensions of photon-to-plasmon couplers are to be understood as exemplary, only.

The photon-to-plasmon coupler 10 shown in an exemplary fashion in FIG. 1 may exhibit a strong evanescent field at frequencies corresponding to 780 nm vacuum wavelength which is accessible with single emitters. For characterization and optimization a full 3D simulation of the structure has been performed and the coupling efficiency η has been calculated.

The rectangular dielectric waveguide 20 of the photon-to-plasmon coupler 10 shown in FIG. 1 is tapered at one end. The increasing evanescent part of the waveguide's electromagnetic field couples over gaps 60 and 70 to the V-shaped metal arms 40, 50 which merge with the plasmonic waveguide near the taper tip into a straight rectangular metal waveguide 30 for surface plasmons.

The coupler-structure is completely defined by both waveguide's cross sections (which are fixed after matching their effective refractive indices) and four free parameters: i) the distance De of the metal arms from the dielectric waveguide at their ends, i) the width D of the gaps 60 and 70 between dielectric and metal in the taper region, iii) the width Wp of the metal arms, and iv) the length L1 of the tapered region (see FIG. 1).

The materials considered here are silicon-nitride (Si3N4) for the dielectric and gold (Au) for the plasmonic waveguides on a silica-substrate (SiO2). The structure has been optimized for a wavelength of 780 nm with the relative permeabilities ∈′+i∈″ of 3.99 (Si3N4), 2.37 (SiO2) and −22.46+i1.39 (Au). These values respectively correspond to refractive indices n′+in″ of 1.9974, 1.5388 and 0.1754+i4.9123.

Since coupling of single emitters to the structures on the chip for example by nano-manipulation techniques is desired, gold has been chosen over silver because it does not oxidize and thus can be used without protective capping layers.

Silicon nitride on SiO2 is chosen for convenience, as it is commercially available grown on silicon wavers, nicely processable by lithography and widely used in waveguiding. Compared to silicon, Si3N4 has a wide bandgap and is used for integrated optical structures in the visible spectral range. This general coupler-scheme fulfils heavy demands for easy fabrication since it only requires standard e-beam lithography methods.

For the simulations a commercial FEM Maxwell's equations-solver (JCMwave) has been used which allows for full 3D computations and supports non-uniform and adaptive meshing. FEM generates relatively fast and accurate simulation results for setups involving metals and complex 3D geometries, also convergence checks are straight-forward. In order to optimize the structure towards a high coupling efficiency the Taguchi-method has been used which is well known in the field of design of experiments (DoE). Taguchi's statistical method strongly reduces the number of computational runs. In this case with 4 parameters (De, D, Wp, L1) where each is varied over a reasonable range in 3 steps (levels), the number of required runs can be reduced to 9 (instead of 3⁴=81 generally needed to check all possible combinations of 4 parameters and 3 levels). The combination of FEM with the Taguchi-method makes the approach very time-efficient.

First, the performance of the uncoupled photonic and plasmonic waveguides is investigated. With a propagating mode solver it is searched for thickness and height of the rectangular waveguides where single mode operation is ensured. The importance of these first calculations is threefold: i) a field distribution for the dielectric waveguide is computed which can be used as a source for the full coupler computations, ii) the effective refractive indices n_{eff} (and thus their propagation constants β=2π*Re(n_{eff})/λ) of the dielectric and those of the plasmonic modes can be matched, and iii) the damping of the surface plasmons in the metal waveguide can be derived. With the source thus generated, the simulations of the coupler can be performed.

A very important step in coupler design is a precise and reliable evaluation of the coupling efficiency η. The evaluation method uses the fact that only the guided field, i.e. the plasmon will be confined to the metallic waveguide over longer distances in contrast to scattered fields. Therefore, a total of 5 μm of plasmon waveguide is retained in the computational domain and the Poynting vector fields in planes perpendicular to the propagation direction in equal steps along the waveguide are exported. By summing up over all points of the exported fields the flux Φ can be obtained through these surfaces.

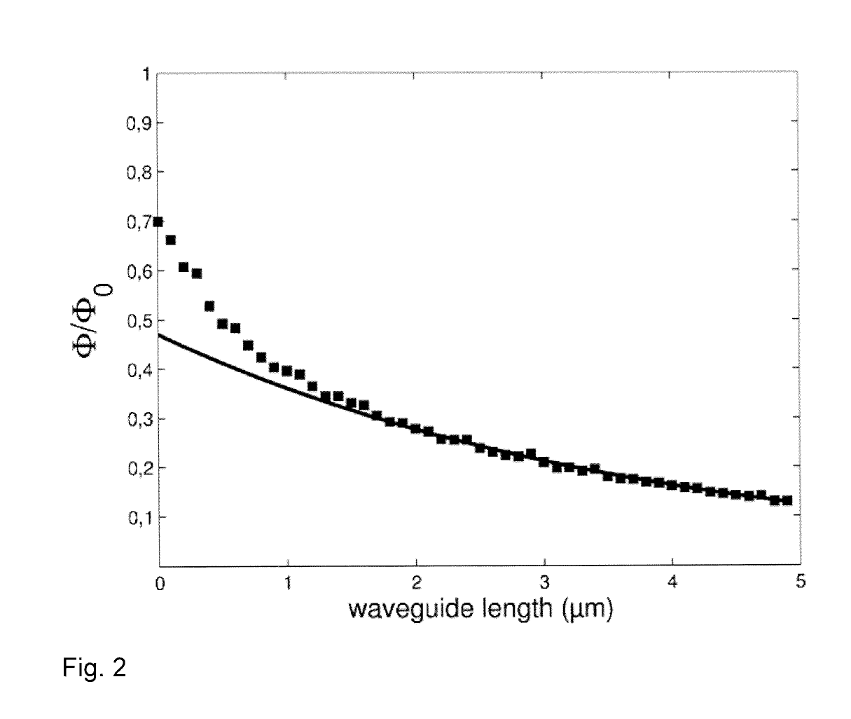

FIG. 2 shows the results for the optimized structure where a fast decay followed by a slower exponential decay can be clearly observed. The latter is fit with a mono-exponential model f(z)=A0 exp(−αz) where α is the attenuation constant of the plasmon mode derived from the propagating mode solver (α=4π Im(n_{eff})/λ). The amplitude A0 which is the only open parameter of the fit gives us the coupling efficiency η directly after the coupler, i.e. where the metal stripe waveguide begins (after normalization to the source field's energy-flux Φ0). It is noted that the method is independent of assumptions regarding power-orthogonality. This is in contrast to several other methods that have been utilized in prior art. It is also emphasized that the method used here does not simply place a “monitor” at the end of the coupler which would easily lead to an overestimated coupling efficiency η.

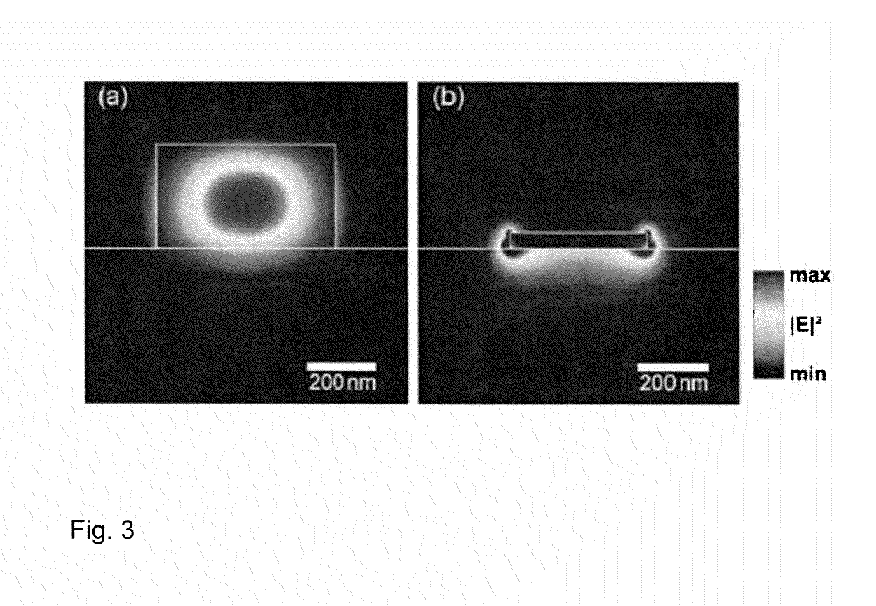

For both waveguides two guided modes are found, a purely TE and TM mode for the dielectric waveguide, whereas there are two TEM modes for the metal waveguide. The field distributions of the momentum-matched modes for both waveguides are depicted in FIG. 3.

An n_{eff-diel} of 1.6886 for the TE mode of the dielectric waveguide with a height of 300 nm and a width of 510 nm and an n_{eff-metal} of 1.6871+i0.0166 for the metallic waveguide with a height of 50 nm and a width of 400 nm is found, respectively. The imaginary part of n_{eff-metal} corresponds to a decay constant of α=3.74 μm. The TE mode has been chosen due to geometric reasons: since its evanescent field is pronounced at the sides of the waveguide it will couple over the gap in the tapered region and its polarization parallel to the silica-substrate SiO2 surface is well suited to polarize the metal arms and thus excite plasmons.

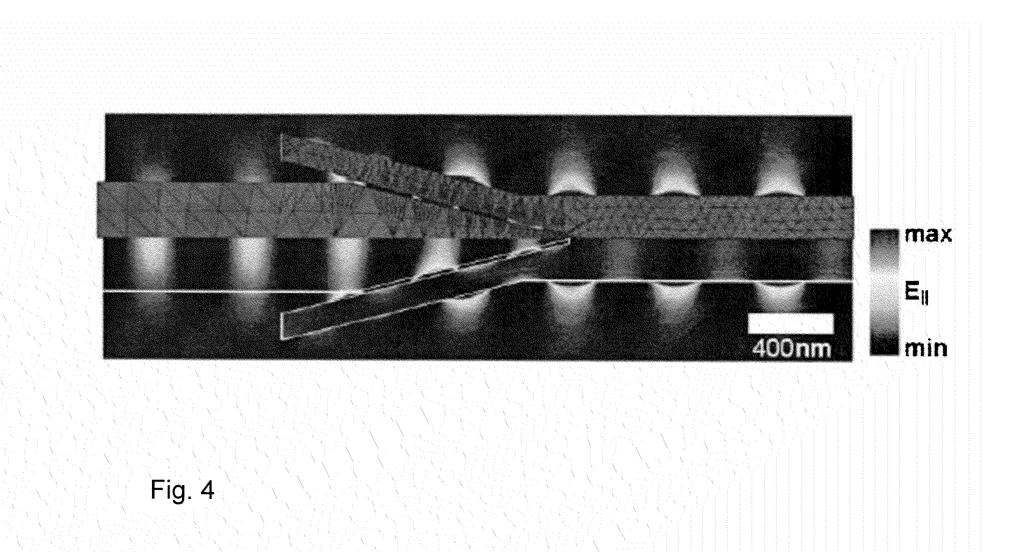

Now the coupler problem is computed. After the Taguchi-optimization the best coupling efficiency of η=47% is found for the parameters De=100 nm, D=24 nm, Wp=120 nm and L1=1030 nm. The mesh of the coupler problem and the field distribution are shown in FIG. 4. It is pointed out that by capping the structure with a higher index dielectric than air and using silver instead of gold, higher coupling efficiencies η's above 60% can easily be reached.

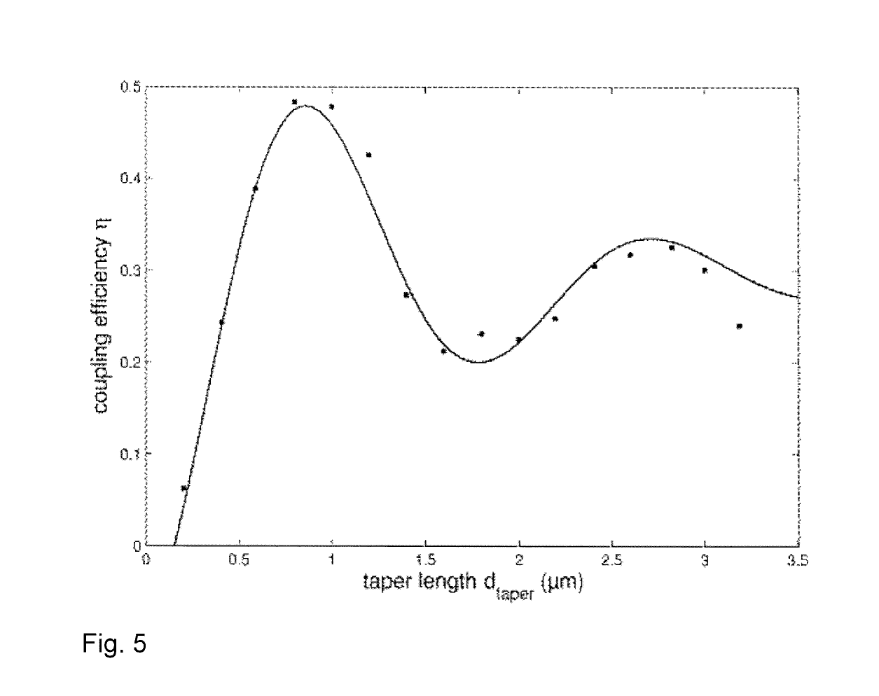

A drawback of the Taguchi-method is the missing insight into the importance of the individual parameters on the result. In order to analyze effects caused by imperfections in fabrication four parameter scans have been performed. Starting from the optimized structure the parameter may be varied while keeping the others fixed. Whereas the three parameters De, D and Wp show only moderate influence on the coupling efficiency η the scan of the taper length L1 reveals a clear oscillatory behavior (FIG. 5). This reflects the working principle of the coupler design: the evanescent part of the dielectric mode excites surface plasmons in the V-shaped metal arms, the electromagnetic energy is then coupled back and forth between the inner and outer edge of the arms while propagating towards the taper-tip. The coupling efficiency η is at its maximum when the taper length L1 is such that most of the electromagnetic energy has coupled to the outer side and fits to the field distribution of the guided plasmon mode. At the same time the taper length L1 has to be kept as short as possible because of dissipative attenuation in the metal arms 40 and 50.

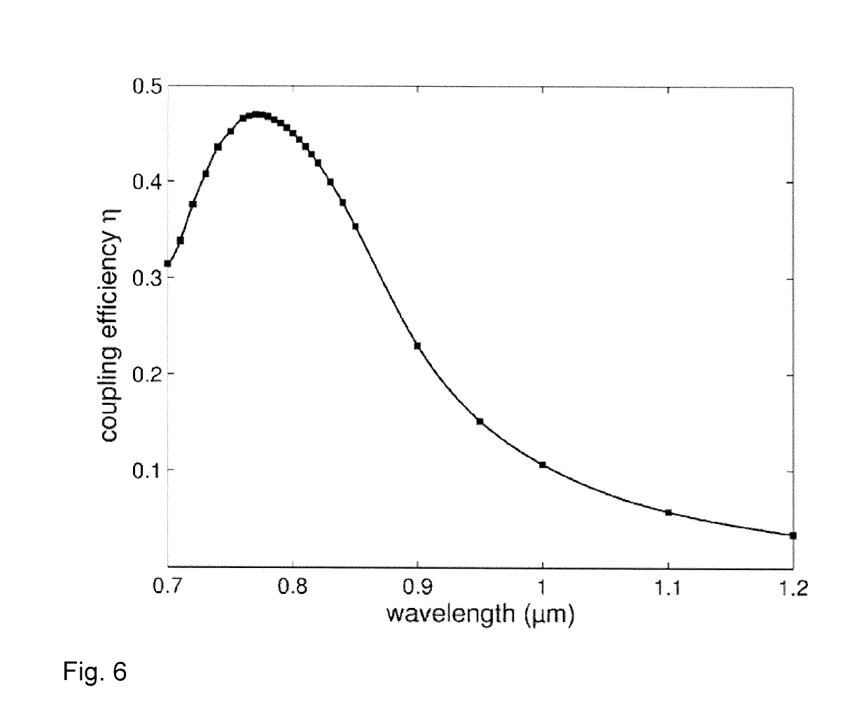

FIG. 6 shows the spectral bandwidth of the coupler by scanning over a variety of input frequencies (dielectric constants taken from Ref. 25). From this a broad bandwidth of approximately 220 nm can be extracted.

In conclusion, an easy-to-fabricate, versatile photon-to-plasmon coupler for on-chip quantum plasmonics has been presented. In contrast to prior art, the focus is on shorter wavelength in the visible spectral range. By using FEM combined with the Taguchi-method a very time-efficient optimization and computation approach executable on conventional PCs has been presented. To avoid overestimated coupling efficiency a simple but reliable method based on the decay of coupled plasmons has been introduced.

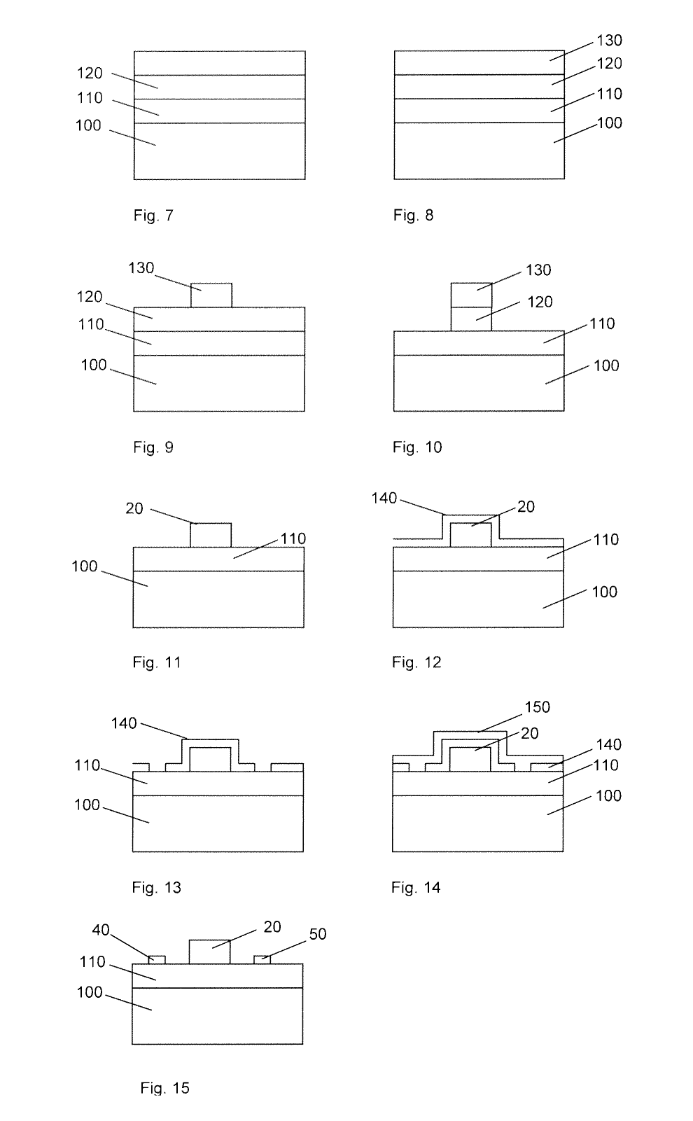

FIGS. 7-15 show exemplary method steps for fabricating the couplers 10 that are shown in FIGS. 1 and 16. The method steps start from a layer structure comprising a silicon wafer 100, a SiO2-layer 110, and a SiN-layer 120 as shown in FIG. 7.

FIGS. 8, 9 and 10 show the fabrication of the photonic strip waveguide 20. The SiN-layer 120 is structured by a lithography step that includes a photo resist layer 130 and an etch step. The photonic strip waveguide 20 is formed by a remaining strip in the SiN-layer 120.

Thereafter, the two plasmonic strip waveguides 40 and 50 are fabricated. This is shown in FIGS. 12-15. The photonic strip waveguide 20 is covered by a second photoresist layer 140. Then, a metal layer 150 is deposited thereon. By removing the buried photoresist layer 140 the photonic strip waveguides 40 and 50 are completed.

### REFERENCE NUMERALS

10 photon-to-plasmon coupler
20 photonic waveguide
21 end section
22 middle section
30 plasmonic waveguide
40 plasmonic strip waveguide
42 first section
43 second section
50 plasmonic strip waveguide
51 Y-shaped plasmonic strip waveguide structure
52 first section
53 second section
60 stripe-like gap
70 stripe-like gap
100 silicon wafer
110 Si02-layer
120 SiN-layer
130 photo resist layer
140 photo resist layer
150 metal layer
D width of the gaps
De distance
L1 length
L2 length
Wd width of the photonic waveguide
Wp width of plasmonic strip waveguide

### LITERATURE

[1] Z. Jacob and V. M. Shalaev, Science (New York, N. Y.) 334, 463 (2011).
[2] W. L. Barnes, A. Dereux, and T. W. Ebbesen, Nature 424, 824 (2003).
[3] a V. Akimov, A. Mukherjee, C. L. Yu, D. E. Chang, a S. Zibrov, P. R. Hemmer, H. Park, and M. D. Lukin, Nature 450, 402 (2007).
[4] D. E. Chang, A. S. Sørensen, E. a. Demler, and M. D. Lukin, Nature Physics 3, 807 (2007).
[5] R. W. Heeres, S. N. Dorenbos, B. Koene, G. S. Solomon, L. P. Kouwenhoven, and V. Zwiller, Nano Letters 10, 661 (2010).
[6] N. Nozhat and N. Granpayeh, OPTICS 284, 3449 (2011).
[7] B. Zhang and S. Du, Optics Communications 281, 5756 (2008).
[8] R. a Wahsheh, Z. Lu, and M. a G. Abushagur, Optics Express 17, 19033 (2009).
[9] B. Lau, M. a Swillam, and A. S. Helmy, Optics Express 18, 27048 (2010).
[10] R. Yang, R. a Wahsheh, Z. Lu, and M. a G. Abushagur, Optics Letters 35, 649 (2010).
[11] J. Tian, S. Yu, W. Yan, and M. Qiu, Applied Physics Letters 95, 013504 (2009).
[12] A. Degiron, S.-Y. Cho, T. Tyler, N. M. Jokerst, and D. R. Smith, New Journal of Physics 11, 015002 (2009).
[13] Y. Song, J. Wang, Q. Li, M. Yan, and M. Qiu, Optics Express 18, 13173 (2010).
[14] L. Hyun-Shik, S. Jun-Hwa, and L. El-Hang, Journal of the Korean Physical Society 57, 1577 (2010).
[15] J.-S. Shin, M.-S. Kwon, and S.-Y. Shin, Optics Communications 284, 3522 (2011).
[16] Q. Li and M. Qiu, Optics Express 18, 15531 (2010).
[17] W. E. Moerner, New Journal of Physics 6, 88 (2004).
[18] R. Kolesov, B. Grotz, G. Balasubramanian, R. J. Stohr, A. a. L. Nicolet, P. R. Hemmer, F. Jelezko, and J. Wrachtrup, Nature Physics 5, 470 (2009).
[19] A. W. Schell, G. Kewes, T. Hanke, A. Leitenstorfer, R. Bratschitsch, O. Benson, and T. Aichele, 651, 648 (2010).
[20] J. Mu and W. Huang, 16, (2008).
[21] W.-P. Huang, Journal of the Optical Society of America A 11, 963 (1994).
[22] S. Schietinger, M. Barth, T. Aichele, and O. Benson, Nano Letters 9, 1694 (2009).
[23] T. Bååk, Applied Optics 21, 1069 (1982).
[24] G. Ghosh, Optics Communications 163, 95 (1999).
[25] P. B. Johnson and R. W. Christy, Physical Review B 6, 4370 (1972).
[26] A. W. Schell, G. Kewes, T. Schroder, J. Wolters, T. Aichele, and O. Benson, The Review of Scientific Instruments 82, 073709 (2011).
[27] E. Ampem-Lassen, D. A. Simpson, B. C. Gibson, S. Trpkovski, F. M. Hossain, S. T. Huntington, K. Ganesan, L. C. Hollenberg, and S. Prawer, Optics Express 17, 11287 (2009).
[28] M Barth, N Nüsse, Stingl, B Löchel, and O. Benson, Applied Physics Letters 93, 021112 (2008).
[29] J. Hoffmann, C. Hafner, P. Leidenberger, J. Hesselbarth, and S. Burger, in Proceedings of SPIE (SPIE, 2009), p. 73900J-73900J-11.
[30] B. D. Cobb and J. M. Clarkson, Nucleic Acids Research 22, 3801 (1994).
[31] W. J. Diamond, Practical Experiment Designs: For Engineers and Scientists (2001).
[32] P. Berini, Physical Review B 63, (2001).
[33] P. Ginzburg, D. Arbel, M. Orenstein, Opt. Lett. 22, 3288-3290, (2006).
[34] N.-N. Feng, L. D. Negro, Opt. Lett. 21, 3086-3088, (2007)
[35] R. A. Wahsheh, M. A. G. Abushagur, Opt. Express 21, 19033, (2009)
[36] C. Delacour et al., Nano Lett. 10, 2922-2926, (2010)
[37] M. Kang, J. Park, B. Lee, Opt. Express 17, 676-687, (2009)
[38] J. Andkjaer et al., J. Opt. Soc. Am. B, 27, 1828-1823, (2010)
[39] G. Kewes et al. Appl. Phys. Lett., 102, 051104, (2013)

1. Photon-to-plasmon coupler for converting photons to plasmons or vice versa, said photon-to-plasmon coupler comprising
a photonic waveguide for guiding photons,
a plasmonic waveguide for guiding plasmons, and
two plasmonic strip waveguides,
each of said two plasmonic strip waveguides being connected to said plasmonic waveguide and embracing an end section of the photonic waveguide such that each of said plasmonic strip waveguides is optically coupled to the end section of the photonic waveguide.

2. Photon-to-plasmon coupler according to claim 1 wherein the two plasmonic strip waveguides form a Y-shaped plasmonic strip waveguide structure that converges towards the plasmonic waveguide and embraces the end section of the photonic waveguide.

3. Photon-to-plasmon coupler according to claim 2 wherein two stripe-like gaps are formed between the Y-shaped plasmonic strip waveguide structure and the end section of the photonic waveguide.

4. Photon-to-plasmon coupler according to claim 1 wherein the plasmonic strip waveguides are plasmonically decoupled from one another by the end section of the photonic waveguide.

5. Photon-to-plasmon coupler according to claim 1 wherein each of the plasmonic strip waveguides is separated from the end section of the photonic waveguide by a stripe-like gap.

6. Photon-to-plasmon coupler according to claim 5 wherein the width of the gap between one of said plasmonic strip waveguides and the end section of the photonic waveguide equals the width of the gap between the other one of said plasmonic strip waveguides and the end section of the photonic waveguide.

7. Photon-to-plasmon coupler according to claim 5 wherein the ratio between the width of the gap and the width of said plasmonic strip waveguides is between 0.01 and 2.

8. Photon-to-plasmon coupler according to claim 1 wherein the waveguide width of the plasmonic strip waveguides is at least partially constant along the propagation direction of the photons and plasmons.

9. Photon-to-plasmon coupler according to claim 1 wherein each of said plasmonic strip waveguides comprises a first section being coupled to the photonic waveguide, and a second section that is less coupled to the photonic waveguide than the first section or entirely decoupled from the photonic waveguide.

10. Photon-to-plasmon coupler according to claim 9 wherein the width of the gap between the first section of each of said plasmonic strip waveguides and the end section of the photonic waveguide is at least partially constant along the propagation direction of the photons and plasmons.

11. Photon-to-plasmon coupler according to claim 9 wherein the ratio between the length of the second section of each of said plasmonic strip waveguides and the width of the photonic waveguide is between 1 and 4.

12. Photon-to-plasmon coupler according to claim 1 wherein the photonic waveguide comprises a middle section adjacent to the end section, the waveguide width of the middle section of the photonic waveguide being larger than the width of each of the plasmonic strip waveguides or equal to it.

13. Photon-to-plasmon coupler according to claim 1 wherein the end section of the photonic waveguide is tapered.

14. Photon-to-plasmon coupler according to claim 13 wherein the end section of the photonic waveguide is adiabatically tapered.

15. Photon-to-plasmon coupler according to claim 1 wherein the plasmonic waveguide is a strip waveguide and forms a third plasmonic strip waveguide of the photon-to-plasmon coupler.

16. Photon-to-plasmon coupler according to claim 1 wherein the plasmonic waveguide is a slot waveguide that is connected to each of the plasmonic strip waveguides.

17. Photon-to-plasmon coupler according to claim 1 wherein the width of each of the plasmonic strip waveguides is smaller than the width of the plasmonic waveguide.

18. Photon-to-plasmon coupler for converting photons to plasmons or vice versa, said photon-to-plasmon coupler comprising
a photonic waveguide for guiding photons,
a plasmonic waveguide for guiding plasmons, and
two plasmonic strip waveguides, that converge towards the plasmonic waveguide and form a Y-shaped plasmonic strip waveguide structure,
said Y-shaped plasmonic strip waveguide structure being optically coupled to an end section of the photonic waveguide.

19. Photon-to-plasmon coupler for converting photons to plasmons or vice versa, said photon-to-plasmon coupler comprising
a photonic waveguide for guiding photons,
a plasmonic waveguide for guiding plasmons, and
two plasmonic strip waveguides,
each of said two plasmonic strip waveguides being coupled to an end section of the photonic waveguide but separated from the end section of the photonic waveguide by a gap.
